(19) United States
(12) Patent Application Publication
(10) Pub. No.: US 2021/0283748 A1
(43) Pub. Date: Sep. 16, 2021

(54) DRILLING METHOD

(71) Applicant: Honda Motor Co., Ltd., Tokyo (JP)

(72) Inventors: Naruhiko OKUBO, Tochigi (JP); Takashi KOBAYASHI, Tochigi (JP); Kenichi FUKAMI, Tochigi (JP); Seiichi KOUKETSU, Tochigi (JP)

(73) Assignee: Honda Motor Co., Ltd., Tokyo (JP)

(21) Appl. No.: 17/199,454

(22) Filed: Mar. 12, 2021

(30) Foreign Application Priority Data
Mar. 13, 2020 (JP) 2020-043741

(51) Int. Cl. B24C 1/08; B23H 9/02

(52) U.S. Cl. CPC B24C 1/083; B23H 9/02

(57) ABSTRACT

A drilling method capable of preventing hole clogging easily and at low cost is provided. A drilling method of the disclosure includes: a hole forming step in which a surface of a workpiece is drilled to form at least one penetration hole from the surface to a back surface of the workpiece; a liquid intrusion step in which the workpiece is immersed in a tank containing a liquid, and the inside of the tank is decompressed to a predetermined pressure to allow the liquid to intrude into the penetration holes; a liquid solidification step in which the liquid that has intruded into the penetration holes is solidified after the workpiece is taken out of the tank; and a burr removing step in which the surface of the workpiece is blasted to remove burrs formed around openings of the penetration holes.

### CROSS-REFERENCE TO RELATED APPLICATIONS

This application claims the priority benefit of Japanese Patent Application No. 2020-043741, filed on Mar. 13, 2020. The entirety of the above-mentioned patent application is hereby incorporated by reference herein and made a part of this specification.

### BACKGROUND

### Technical Field

The disclosure relates to a drilling method.

### Related Art

With regard to a workpiece in which a large number of fine penetration holes are formed, the original workpiece is drilled using a processing technique such as mechanical processing, laser processing, or the like. In particular, when the drilling is performed by the laser processing, burrs are generated on an incident side of a laser beam due to removed materials of the workpiece. The burrs are removed by blasting a surface of the drilled workpiece.

For example, in Patent literature 1, a technique is disclosed in which icy grains and water are mixed to a predetermined concentration in an icy grain mixing tank to obtain ice slurry, the ice slurry is supplied to an injection gun by a gun supply pump, high-pressure water at an arbitrary pressure is supplied from a high-pressure water manufacture device to the injection gun, and the ice slurry is injected onto the object to be processed by the high-pressure water to remove burrs generated on the surface of the object to be processed. According to the technique, it is said that the burrs can be removed even when the object to be processed, that is, the workpiece is made of metal and the generated burrs are made of metal.

### LITERATURE OF RELATED ART

### Patent Literature

Patent literature 1: Japanese Patent Laid-Open No. 2005-254368

However, with respect to the workpiece, because the penetration holes are formed obliquely in a manner of being inclined in a thickness direction of the workpiece (from the processed surface toward a back-surface side) and a hole diameter is also small, when a medium used for the blasting collides with the burrs, the burrs are separated from the workpiece surface, but may clog inside the holes. Therefore, in a case of the workpiece in which a large number of the fine penetration holes are formed, there is a problem that the drilled workpiece cannot sufficiently fulfill a function thereof.

### SUMMARY

The disclosure provides a drilling method capable of preventing hole clogging easily and at low cost.

The disclosure relates to a drilling method, including: a hole forming step in which a surface of a workpiece is drilled to form at least one penetration hole from the surface to a back surface of the workpiece; a liquid intrusion step in which the workpiece is immersed in a tank containing a liquid, and a space above the liquid in the tank is exhausted to allow the liquid to intrude into the penetration holes; a liquid solidification step in which the liquid that has intruded into the penetration holes are cooled and solidified after the workpiece is taken out of the tank; and a burr removing step in which the surface of the workpiece is blasted to remove burrs formed around openings of the penetration holes.

According to the drilling method of the disclosure, if the workpiece is drilled using a laser, when the burrs formed at the hole openings are removed, in order to make the separated burrs not enter the inside of the penetration holes to clog the holes, the liquid is filled into the inside of the holes and the liquid is solidified. Thereby, the penetration holes are plugged so as to prevent the burrs from entering the inside of the penetration holes. At that time, by controlling at a predetermined decompression degree, a large number of the fine penetration holes formed in the workpiece can be confirmed to be filled with the liquid, and thus the clogging of the penetration holes due to the burrs can be reliably suppressed.

Moreover, because the solidified liquid embedded in the penetration holes is returned to the liquid due to being left at a room temperature, heat treatment, or the like, the penetration holes of the workpiece are provided in a clean state without being clogged with the debris of the burrs and the like. Therefore, the drilled workpiece can sufficiently fulfil the function thereof.

In addition, in the disclosure, in order to allow the liquid to intrude into the penetration holes, in the liquid intrusion step, the workpiece is immersed in the tank containing the liquid, and then the inside of the tank is exhausted and returned to an atmospheric pressure. This is because the penetration holes formed in the workpiece are fine, for example, on an order of μm to mm, and thus the liquid does not intrude into the penetration holes if the air remaining in the penetration holes is not forcibly exhausted.

In an aspect of the disclosure, in the liquid intrusion step, the exhaust in the tank can be performed in a manner that the surface and the back surface of the workpiece are sequentially directed toward a liquid surface of the liquid. Thereby, the liquid can be more reliably filled into the inside of the holes, and the clogging of the penetration holes due to the burrs can be suppressed.

In addition, when the immersion and the exhaust, which are performed twice in total, once for the surface and once for the back surface, are completed in one operation, the exhaust in the tank is preferably performed in a manner that the back-surface side of the workpiece facing the liquid surface. Because the burrs are formed on the surface side on which the burrs are attached, the burrs form a resistance against the exhaust of the remaining air. The liquid does not have to be filled to the inside of holes of the burrs which communicate with the penetration holes, but the liquid may be filled at least only to the inside of the penetration holes.

In an aspect of the disclosure, in the liquid solidification step, the cooling and solidification of the liquid can be performed in a state where the surface of the workpiece is directed downward by gravity. In this case, to some extent, the liquid is allowed to escape from the penetration holes due to leakage before the liquid is solidified, the liquid can be reliably solidified inside the penetration holes in the vicinity of the burrs, and the clogging of the penetration holes due to the burrs can be reliably suppressed.

In an aspect of the disclosure, in the hole forming step, the at least one penetration hole can be formed in an oblique direction with respect to the surface of the workpiece. According to the aspect, even with respect to a workpiece in which burrs, which are separated when the burrs are broken or dropped, are pushed into the penetration holes by the blasting and easily clog the inside of the penetration holes, the clogging of the penetration holes due to the burrs can be reliably suppressed.

In an aspect of the disclosure, the burr removing step can be performed using a medium having a temperature equal to or lower than a melting point of the liquid. In this case, during the burr removing, the workpiece can be prevented from being heated due to processing heat, the liquid solidified inside the holes can be prevented from being liquefied, and the clogging of the penetration holes due to the burrs can be suppressed. In addition, the liquid solidification step and the burr removing step can be performed at the same time, and thus the number of the steps of the drilling method of the disclosure can be reduced to further simplify the method, and the method can be executed at low cost.

### BRIEF DESCRIPTION OF THE DRAWINGS

FIG. 1 is a schematic diagram showing a step of a drilling method according to an embodiment of the disclosure.

FIG. 2 is a schematic diagram showing a step of the drilling method according to the embodiment of the disclosure.

FIG. 3 is a diagram showing a principle of the drilling method according to the embodiment of the disclosure.

FIG. 4 is a diagram showing a principle of the drilling method according to the embodiment of the disclosure.

FIG. 5 is a schematic diagram showing a step of the drilling method according to the embodiment of the disclosure.

FIG. 6 is a schematic diagram showing a step of the drilling method according to the embodiment of the disclosure.

FIG. 7 is a schematic diagram showing a step of the drilling method according to the embodiment of the disclosure.

### DESCRIPTION OF THE EMBODIMENTS

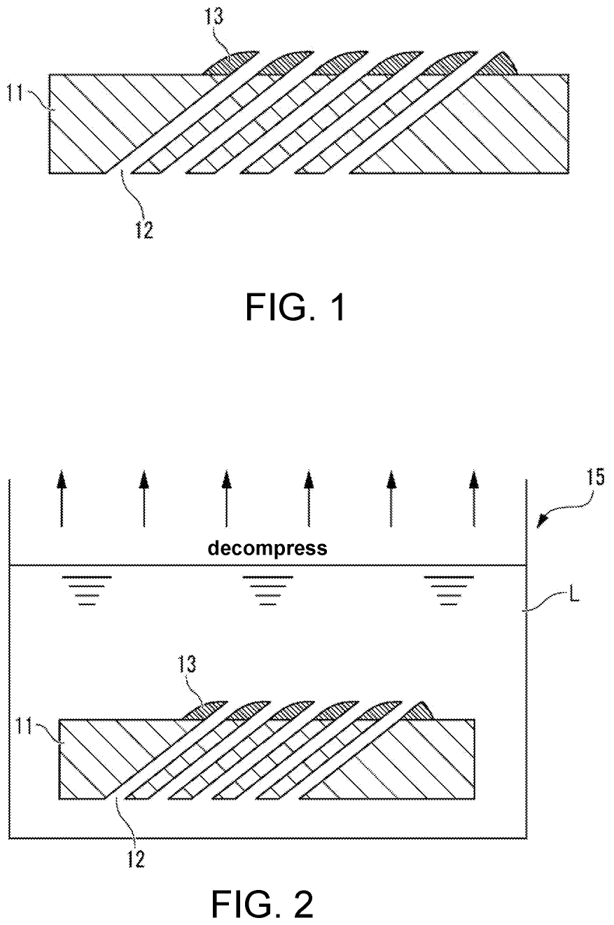

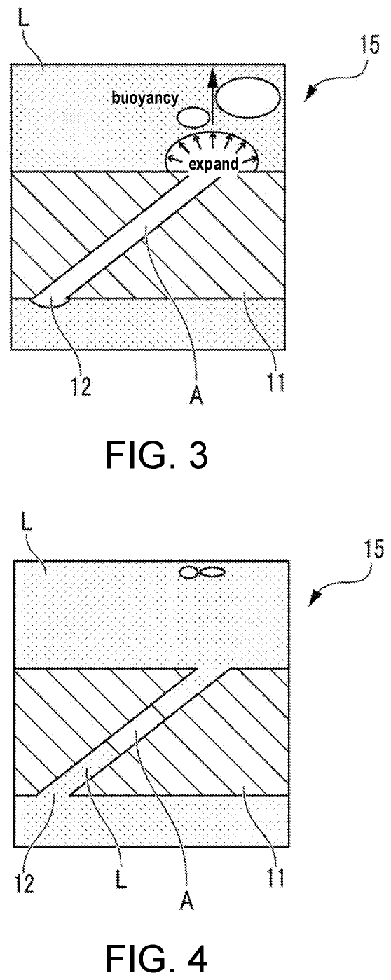

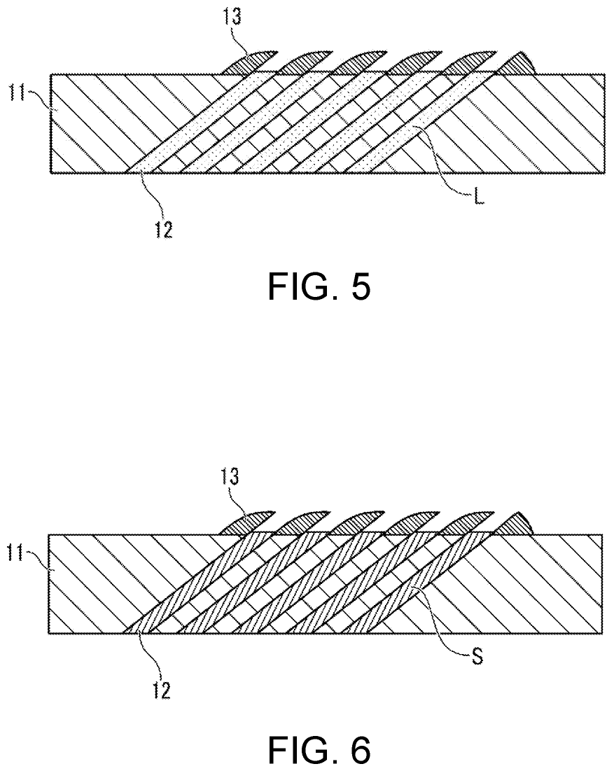

A drilling method is described below in an embodiment of the disclosure. FIG. 1, FIG. 2, and FIGS. 5 to 7 are schematic diagrams showing steps of the drilling method according to the embodiment of the disclosure. FIG. 3 and FIG. 4 are diagrams showing principles of the drilling method according to the embodiment of the disclosure.

First, as shown in FIG. 1, a workpiece 11 is prepared, the workpiece 11 is drilled to form penetration holes 12 in the workpiece 11.

A material configuring the workpiece 11 is not particularly limited, and the workpiece 11 can be configured by any material such as a metal material, a ceramic material, a resin material, or the like according to a use of a final product.

The drilling is also not particularly limited, and any processing method can be used such as mechanical processing using a drill or the like, laser processing using a laser beam, or the like. A hole diameter is not particularly limited, but in the embodiment, the hole diameter is on an order of μm or mm. The disclosure is more effective for this fine penetration hole.

In the laser processing, when the drilling is performed as shown in FIG. 1, around openings of the penetration holes 12, a molten material discharged from the inside of the workpiece 11 is deposited near the openings of the holes, and burrs (dross) 13 are generated.

Then, as shown in FIG. 2, the workpiece 11 is immersed in a tank 15 containing a liquid L. A type of the liquid L is not particularly limited as long as the liquid L is a liquid at a room temperature and a normal pressure, and in addition to water, the liquid L can be an organic solvent such as ethanol, benzene, acetone, chloroform, or the like. Water is preferable because water is easy to obtain and is inexpensive, and the object of the disclosure can be easily achieved by the steps described below.

Moreover, in the step shown in FIG. 2, it is necessary to allow the liquid L to intrude into the penetration holes 12 of the workpiece 11, but as described above, the diameter of the penetration holes 12 is on the order of μm or mm. Therefore, air A remaining in the penetration holes 12 prevents the intrusion of the liquid L, and the liquid L cannot intrude into the penetration holes 12. Thus, in the embodiment, the inside of the tank 15, that is, a space above the liquid L is exhausted from a liquid surface side of the liquid L. The exhaust can be performed using a pump (not shown), and the liquid surface side of the tank 15 is appropriately sealed in order that the exhaust can be performed well.

Then, as shown in FIG. 3, the air A in the penetration holes 12 expands and is exhausted from the openings of the penetration holes 12, and escapes to the surface through the inside of the liquid L. Generally, as shown in FIG. 4, the liquid L intrudes into the penetration holes 12 as soon as the exhaust operation is completed (the atmospheric pressure is released).

Moreover, because a degree of vacuum in the penetration holes 12 is difficult to be directly measured, a degree of vacuum in the tank 15 is generally used instead. The degree of vacuum at this time depends on a working environment, used equipment, and the like, and is set to, for example, −0.09 MPaG or less. In addition, a holding time is about several minutes.

In the embodiment, preferably, a surface and a back surface of the workpiece 11 are sequentially directed toward the liquid surface of the liquid L to exhaust the inside of the tank 15. In this case, the liquid L can be more reliably filled into the inside of the penetration holes 12, and the clogging of the penetration holes 12 due to the burrs 13 can be suppressed.

In addition, when the immersion and the exhaust, which are performed twice in total, once for the surface and once for the back surface, are completed in one operation, the exhaust in the tank 15 is preferably performed in a manner that the back-surface side of the workpiece 11 facing the liquid surface. Because the burrs 13 are formed on the surface side on which the burrs 13 are attached, the burrs 13 form a resistance against the exhaust of the remaining air. The liquid L does not have to be filled to the inside of holes of the burrs 13 which communicate with the penetration holes 12, but the liquid L may be filled at least only to the inside of the penetration holes 12.

As a result of the above, as shown below, the solidified liquid L can be embedded in the entire penetration holes 12, and when the burrs 13 are removed, the removed burrs 13 can be more effectively prevented from being fitted into the penetration holes and being clogged.

Then, as shown in FIG. 6, the liquid L that has intruded into the penetration holes 12 is cooled and solidified to obtain a solidified body S. The cooling and solidification can be performed by a general-purpose method such as spraying a refrigerant on the workpiece 11, or the like.

Moreover, at the time of the cooling and solidification, preferably, the liquid L is cooled and solidified in a state where the workpiece 11 is turned upside down in order that the surface on which the burrs 13 are generated is directed downward by gravity. In this case, to some extent, the liquid L is allowed to escape from the penetration holes 12 due to leakage before the liquid L is solidified, the liquid L inside the penetration hole 12 in the vicinity of the burr 13 can be reliably solidified, and the clogging of the penetration holes 12 due to the burrs 13 can be reliably suppressed.

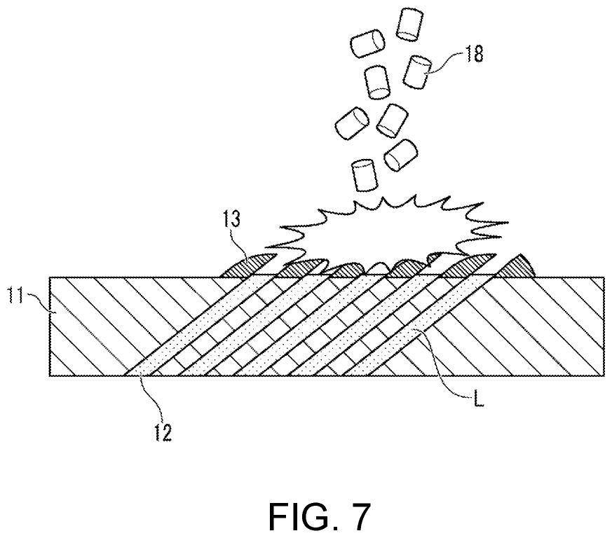

Then, as shown in FIG. 7, a medium is made to collide with the surface of the workpiece 11 and is blasted to remove the burrs 13 generated around the openings of the penetration holes 12. A blasting time is, for example, several minutes to several hours.

Moreover, because the solidified body S embedded in the penetration holes 12 is returned to the liquid L due to being left at a room temperature, heat treatment, or the like, the penetration holes 12 of the workpiece 11 are provided in a clean state without being clogged with the debris of the burrs 13 and the like. Therefore, the drilled workpiece 11 is provided as a final product capable of sufficiently fulfilling the function of the workpiece.

In this way, according to the embodiment, when the burrs 13 formed at the openings of the penetration holes 12 are removed, in order to prevent the broken burrs 13 from being fitted into the inside of the penetration holes 12 and clogging the penetration holes 12, the liquid L is filled into the inside of the penetration holes 12 and the liquid L is solidified. Thereby, the penetration holes 12 are plugged so as to prevent the burrs 13 from entering the inside of the penetration holes 12. At that time, by controlling at a predetermined decompression degree, a large number of the fine penetration holes 12 formed in the workpiece 11 can be confirmed to be filled with the liquid L, and thus the clogging of the penetration holes due to the burrs can be reliably suppressed. Therefore, the drilling method capable of preventing the hole clogging easily and at low cost can be provided.

Moreover, in the burr removing step shown in FIG. 7, the blasting can be performed using the medium having a temperature equal to or lower than a melting point of the liquid L. For example, when water is used as the liquid L, dry ice can be used as the medium. In this case, during the burr removing, the workpiece 11 can be prevented from being heated due to processing heat, the liquid L solidified inside the penetration holes 12 can be prevented from being liquefied, and the clogging of the penetration holes 12 due to the burrs 13 can be suppressed. In addition, the cooling and solidification of the liquid L and the removal of the burrs 13 can be performed at the same time. That is, the steps shown in FIG. 6 and FIG. 7 can be performed at the same time, and thus the number of the steps of the drilling method of the embodiment can be reduced to further simplify the method, and the method can be executed at low cost.

In addition, in the embodiment, the penetration holes 12 are formed in the workpiece 11 in an oblique direction with respect to the surface of the workpiece 11. Therefore, according to the embodiment, even with respect to the workpiece 11 in which the burrs 13, which are separated from the surface of the workpiece 11 when the burrs 13 are broken or dropped, are easily fitted into the inside of the penetration holes 12, the clogging of the penetration holes 12 due to the burrs 13 can be reliably suppressed.

As described above, according to the disclosure, a drilling method capable of preventing hole clogging easily and at low cost can be provided.

Although several embodiments of the disclosure are described above, these embodiments are shown as examples and are not intended to limit the scope of the disclosure. The novel embodiments can be implemented in a variety of other forms, and various omissions, replacements, and changes can be made without departing from the gist of the disclosure. The embodiments and modifications thereof are included in the scope and the gist of the disclosure and are included in the scope of the disclosure described in the claims and the equivalent scope thereof.

What is claimed is:

1. A drilling method, comprising:
a hole forming step in which a surface of a workpiece is drilled to form at least one penetration hole from the surface to a back surface of the workpiece;
a liquid intrusion step in which the workpiece is immersed in a tank containing a liquid, and the inside of the tank is decompressed and exhausted to a predetermined pressure to allow the liquid to intrude into the penetration holes;
a liquid solidification step in which the liquid that has intruded into the penetration holes is solidified after the workpiece is taken out of the tank; and
a burr removing step of in which the surface of the workpiece is blasted to remove burrs formed around openings of the penetration holes.

2. The drilling method according to claim 1, wherein in the liquid intrusion step, the exhaust is performed in a manner that the surface and the back surface of the workpiece are sequentially directed toward a liquid surface of the liquid.

3. The drilling method according to claim 1, wherein in the liquid solidification step, the solidification of the liquid is performed in a state where the surface of the workpiece is directed downward by gravity.

4. The drilling method according to claim 2, wherein in the liquid solidification step, the solidification of the liquid is performed in a state where the surface of the workpiece is directed downward by gravity.

5. The drilling method according to claim 1, wherein in the hole forming step, the at least one penetration hole is formed in an oblique direction with respect to the surface of the workpiece.

6. The drilling method according to claim 2, wherein in the hole forming step, the at least one penetration hole is formed in an oblique direction with respect to the surface of the workpiece.

7. The drilling method according to claim 3, wherein in the hole forming step, the at least one penetration hole is formed in an oblique direction with respect to the surface of the workpiece.

8. The drilling method according to claim 4, wherein in the hole forming step, the at least one penetration hole is formed in an oblique direction with respect to the surface of the workpiece.

9. The drilling method according to claim 1, wherein in the burr removing step, the blasting is performed using a medium having a temperature equal to or lower than a melting point of the liquid.

10. The drilling method according to claim 2, wherein in the burr removing step, the blasting is performed using a medium having a temperature equal to or lower than a melting point of the liquid.

11. The drilling method according to claim 3, wherein in the burr removing step, the blasting is performed using a medium having a temperature equal to or lower than a melting point of the liquid.

12. The drilling method according to claim 4, wherein in the burr removing step, the blasting is performed using a medium having a temperature equal to or lower than a melting point of the liquid.

13. The drilling method according to claim 5, wherein in the burr removing step, the blasting is performed using a medium having a temperature equal to or lower than a melting point of the liquid.

14. The drilling method according to claim 6, wherein in the burr removing step, the blasting is performed using a medium having a temperature equal to or lower than a melting point of the liquid.

15. The drilling method according to claim 7, wherein in the burr removing step, the blasting is performed using a medium having a temperature equal to or lower than a melting point of the liquid.

16. The drilling method according to claim 8, wherein in the burr removing step, the blasting is performed using a medium having a temperature equal to or lower than a melting point of the liquid.
